(19) United States
(12) Patent Application Publication
(10) Pub. No.: US 2003/0182782 A1
(43) Pub. Date: Oct. 2, 2003

(54) Machining system with multiaxial movement

(75) Inventors: Norbert Hessbruggen, Salach (DE); Jurgen Walz, Frickenhausen (DE); Christoph Wernz, Stuttgart (DE); Hans Georg Boehringer, Nellingen (DE)

Correspondence Address: THE FIRM OF KARL F ROSS, 5676 RIVERDALE AVENUE, PO BOX 900, RIVERDALE (BRONX), NY, 10471-0900, US

(73) Assignee: EMAG Maschinenfabrik GmbH

(21) Appl. No.: 10/386,988

(22) Filed: Mar. 12, 2003

(30) Foreign Application Priority Data
Mar. 26, 2002 (DE) 10213755.2

(51) Int. Cl. B23P 23/02; B23C 1/14

(52) U.S. Cl. 29/27 C; 409/235; 409/168; 409/221; 74/490.01; 74/490.07

(57) ABSTRACT

A machining system has a frame defining at least one work station, a guide extending in a first direction on the frame, first and second slides movable independently of each other on the guide, and a support having a pair of sides. Respective first and second main links each have one end pivoted on the support at a respective one of the sides and an opposite end pivoted on a respective one of the slides. A machining unit is carried on the support. Actuators connected to the slides can independently move them and thereby pivot the support and unit about an axis perpendicular to the guide and move the support and unit parallel and transverse to the guide.

### FIELD OF THE INVENTION

The present invention relates to a machining system. More particularly this invention concerns a machining system with multiaxial movement of a workpiece/tool holder.

### BACKGROUND OF THE INVENTION

A machining systems is known having a machining unit that can pick a workpiece up from a supply station, move it to a work station and hold it there while it is machined, and then move it back to the supply station or an output station. The workpiece can be moved through more than one work station and can even be rotated while in one of the stations for lathe-type machining.

U.S. Pat. No. 6,328,510 describes such a triaxial machine where the machining unit in carried on one end of a first link whose opposite end is pivoted on a slide on a guide on one side of the machine frame. Another link has one end pivoted on another guide on the opposite side of the machine and an opposite end pivoted near the machining unit on the first link. Appropriate movement of the two slides can move the machining unit along a relatively complex path between the two guides. While fairly effective, such a system is still quite bulky and does not permit certain orientations of the machining unit, for instance rotating the workpiece about a horizontal and vertical axis.

European patent document 1,106,304 of Walker, Link, Hafla, and Haberkern describes another substantially more complex system using three pairs of variable-length links all having upper ends connected to the machine frame and lower ends connected to the machining unit. While the positioning possibilities of the machining unit are very great, such a system is extremely complex and quite bulky.

### OBJECTS OF THE INVENTION

It is therefore an object of the present invention to provide an improved machining system.

Another object is the provision of such an improved machining system which overcomes the above-given disadvantages, that is which is simple and compact, yet which still offers several degrees of movement within the machine frame.

### SUMMARY OF THE INVENTION

A machining system has according to the invention a frame defining at least one work station, a guide extending in a first direction on the frame, first and second slides movable independently of each other on the guide, and a support having a pair of sides. Respective first and second main links each have one end pivoted on the support at a respective one of the sides and an opposite end pivoted on a respective one of the slides. A machining unit is carried on the support. Actuators connected to the slides can independently move them and thereby pivot the support and unit about an axis perpendicular to the guide and move the support and unit parallel and transverse to the guide.

The invention is based on the recognition that it in advantageous to mount the tool or workpiece holder, that is the machining unit, on at least a four-element linkage here comprised of the guide, the first and second links, and the support. Thus the machining unit can be moved horizontally and vertically when the guide is horizontal, and can also be pivoted about a horizontal axis perpendicular to the guide using a single guide to one side of the work stations. The slides are moved parallel to each other to produce machining-unit movement that is both parallel to the guide and perpendicular to it.

According to the invention the frame includes a supply station for holding a workpiece to be machined. The machining unit is provided with a chuck for gripping the workpiece, although it is within the scope of the invention for the machining unit to hold a tool acting on a stationary workpiece. The work station is provided with a tool for machining the workpiece gripped by the chuck.

The ends of the links are pivoted at axes all generally parallel to each other. In addition the links can be of fixed lengths between their ends or one of them can be of variable length. It is also possible for the first and second links to cross, an arrangement that, like the variable-length link, allows the linkage to be very compact.

The machining system according to the invention further has a third slide movable along the guide independently of the first and second slides, a secondary link having one and pivoted on one of the main links between the ends thereof and an opposite end pivoted on the third slide, and a third actuator connected to the third slide for displacing same controlledly along the guide. Such a construction in very handy for pivoting the machining unit.

The chuck according to the invention can work by the pick-up principle, that is lifting the workpieces one at a time out of a supply/infeed station, taking them to one or more work stations where they are machined, and then dropping the finished workpiece off in an outfeed station. Furthermore the workpiece holder can be a carousel or turntable.

### BRIEF DESCRIPTION OF THE DRAWING

The above and other objects, features, and advantages will became more readily apparent from the following description, reference being made to the accompanying drawing in which:

FIG. 1 is a partly schematic side view of the system of this invention;

FIG. 1A is a horizontal section taken along plans IA-IA of FIG. 1;

FIG. 2 is a view like FIG. 1 showing the system in another position; and

FIGS. 3 and 4 are views like FIG. 1 of variants on the system of this invention.

### SPECIFIC DESCRIPTION

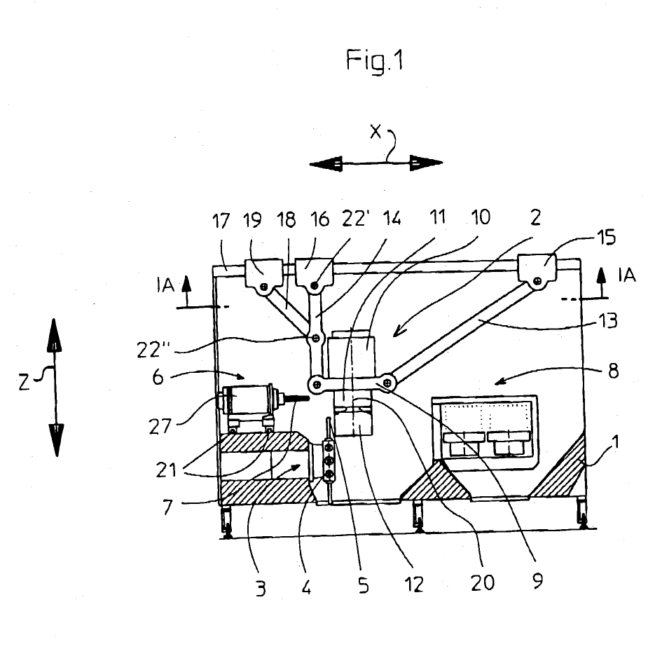

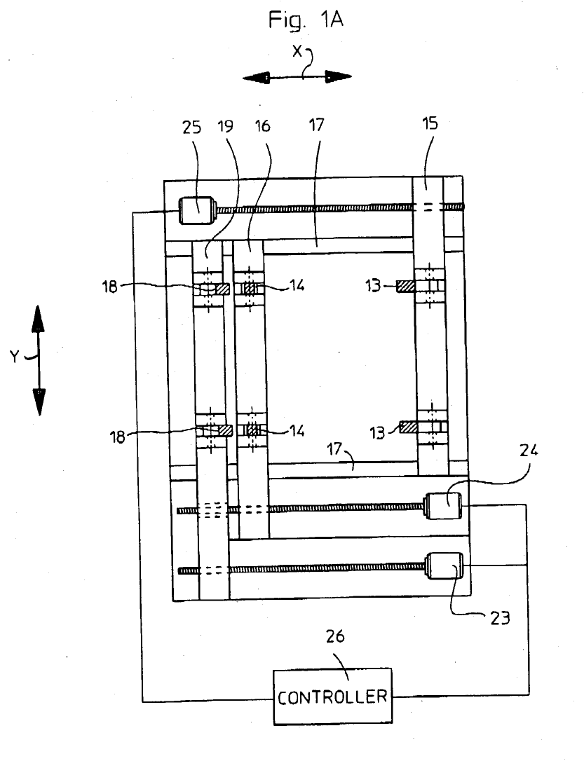

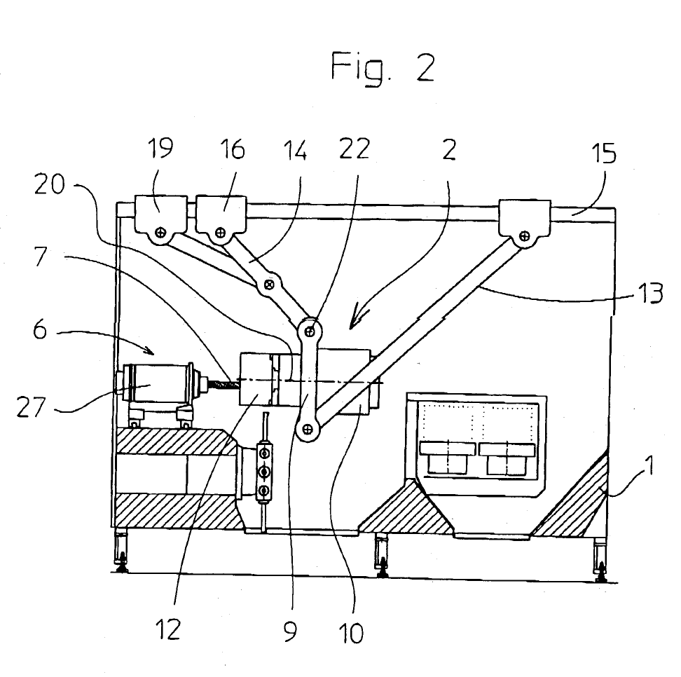

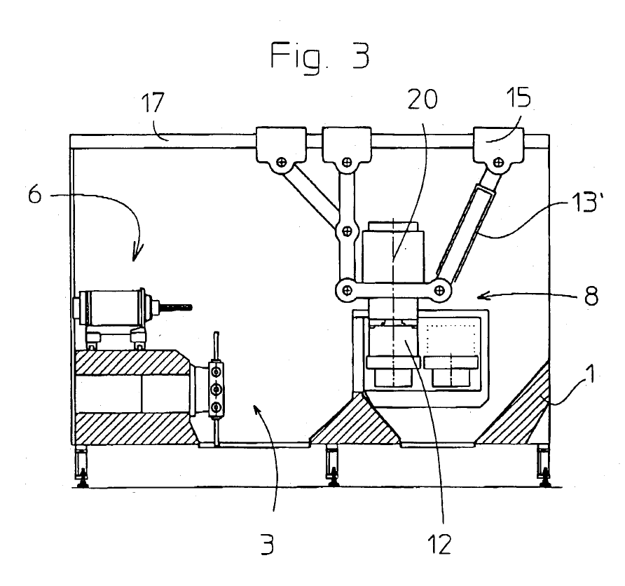

As seen in FIGS. 1, 1A, and 2, a machining system according to the invention has a stationary frame 1 having two machining stations 3 and 6, a conveyor 8 for bringing in and taking out workpieces 12, and a linkage described below and supported on horizontal guide rails 17 bridging the upper region of the frame 1. A machining unit 2 carried on this linkage comprises a motor 10 capable of rotating a chuck 11 about an axis 20. The chuck 11 is configured to hold the workpieces 12.

The station 3 is comprised of a turret 4 carrying a plurality of tools 5, here lathe bits. The station 6 has a drive 27 for rotating a tool 7 about an axis lying in a plane defined by a horizontal axis or direction X and a vertical axis or direction Z, the guide rods 17 extending parallel to the axis X. The drive 27 is mounted on rails 21 for displacement in a horizontal axis or direction Y (FIG. 1A) perpendicular to the plane of the directions X and Z.

The linkage 2 is formed by a generally flat and planar frame 9 to one face of which is secured the motor 10 and at the other face of which is the holder or chuck 11, with the frame 9 extending perpendicular to the workpiece axis 20. One side of the frame 9 is pivoted on the lower ends of a pair of parallel main link arms 13 having upper ends pivoted coaxially on a slide 15 carried on the rods 17. The other side of the frame 9 is similarly pivoted on the lower ends of a pair of parallel shorter main link arms 14 having upper ends pivoted coaxially at an axis 22′ on another slide 16 on the rods 17. A pair of secondary link arms 18 stave lower ends pivoted at 22″ in the middles of the links 14 and upper ends pivoted coaxially on a third slide 19 on the rods 17. The pivot axes of the links 13, 14, and 18 are all parallel, and the slide 16 is between the slides 15 and 19. Respective actuators 23, 24, and 25 operated by a controller 26 are connected to the slides 19, 16, and 15, respectively, and can move them independently of one another.

With this system the linkage can therefore pivot the machining unit 2 about an axis perpendicular to the axis 20 and parallel to the axis Y and can also move the machining unit 2 up and down in the direction Z as well as horizontally parallel to the guide rods 17 In the direction X. More particularly as seen by a comparison of FIGS. 1 and 2, leftward movement of the slides 15, 16, and 19 through different distances can pivot the unit 2 to move from an orientation where the workpiece 12 in the chuck 11 is rotated with the axis 20 vertical adjacent the station 3 for lathe-like machining to a position with the workpiece 12 not rotating and the axis 20 horizontal for engagement with the tool 7. In this position movement of the slides 15, 16, and 19 synchronously bores a hole in the workpiece 12 parallel to the axis 20, although of course the tool 7 can also serve for milling, threading or any other similar machining process. Similarly in the FIG. 2 position an unillustrated actuator can move the motor 27 in the direction Y to bore a hole at another location, or to act like a lathe tool if the workpiece 12 to simultaneously being rotated by the motor 10. According to the pick-up principle, the actuators 23, 24, and 25 can move the unit 2 back and forth to the conveyor 8 to pick up an unmachined workpiece and drop off a machined one.

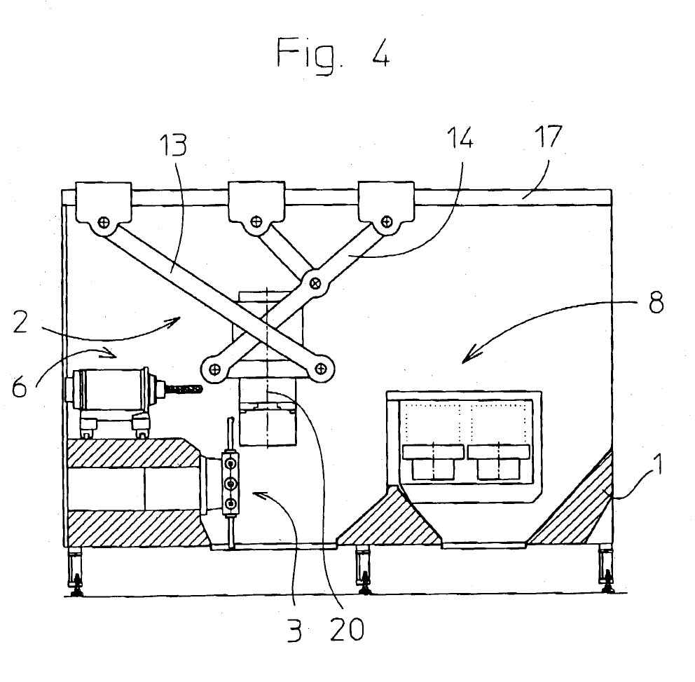

FIG. 4 shows a system like that of FIGS. 1 and 2 except that links 13′ are provided that are of variable length. They can be extended and shortened. The advantage of this structure is that it allows the overall length of the system in the direction X parallel to the guide rods 17 to be minimized. The same effect is achieved by crossing the links 13 and 14 as shown in FIG. 4.

We claim:

1. A machining system comprising:
a frame defining at least one work station;
a guide extending in a first direction on the frame;
first ad second slides movable independently of each other on the guide;
a support having a pair of sides;
respective first and second main links each having one end pivoted on the support at a respective one of the sides and an opposite end pivoted on a respective one of the slides;
a machining unit carried on the supports; and
actuator means connected to the slides for independently moving the slides and thereby pivoting the support and unit about an axis perpendicular to the guide and moving the support and unit parallel and transverse to the guide.

2. The machining system defined in claim 1 wherein the frame includes a supply station for holding a workpiece to be machined, the machining unit being provided with a chuck for gripping the workpiece, the work station being provided with a tool for machining the workpiece gripped by the chuck.

3. The machining system defined in claim 2 wherein the ends of the links are pivoted at axes all generally parallel to each other.

4. The machining system defined in claim 2 wherein the links are of fixed lengths between their ends.

5. The machining system defined in claim 2 wherein one of the links is of variable length.

6. The machining system defined in claim 2 wherein the first and second links cross.

7. The machining system defined in claim 2, further comprising:
a third slide movable along the guide independently of the first and second slides;
a secondary link having one and pivoted on one of the main links between the ends thereof and an opposite end pivoted on the third slide; and
a third actuator connected to the third slide for displacing same controlledly along the guide.

8. The machining system defined in claim 2 wherein there are two such first links extending parallel to each other and two such second links also extending parallel to each other.
